(19) United States
(12) Patent Application Publication
(10) Pub. No.: US 2026/0030478 A1
(43) Pub. Date: Jan. 29, 2026

(54) DEEP NEURAL NETWORK CALCULATION DEVICE FOR CONVERTING AND CALCULATING REPRESENTATION OF DATA AND OPERATION METHOD

(71) Applicant: KOREA UNIVERSITY RESEARCH AND BUSINESS FOUNDATION, Seoul (KR)

(72) Inventors: Jongsun PARK, Seoul (KR); Dong Jun KIM, Seoul (KR)

(21) Appl. No.: 19/278,545

(22) Filed: Jul. 23, 2025

(30) Foreign Application Priority Data
Jul. 24, 2024 (KR) 10-2024-0098025

(51) Int. Cl. G06N 3/04

(52) U.S. Cl. CPC G06N 3/04

(57) ABSTRACT

Disclosed is the calculation device of a deep neural network, which includes a conversion unit that outputs a plurality of conversion data values including bits corresponding to bits included in a plurality of original data values and further including a sign bit based on a sign of each of the plurality of original data values each composed of a plurality of bits, a compression unit that generates compression data, and a calculation preparation unit that outputs a plurality of recovery data values by inverting a value of at least some bits in each of the plurality of conversion data values, and wherein the conversion unit determines an MSB of each of the plurality of original data values as the sign bit, and inverts values of bits included in each of original data values whose signs are negative among the plurality of original data values.

### CROSS-REFERENCE TO RELATED APPLICATIONS

This application claims priority under 35 U.S.C. § 119 to Korean Patent Application No. 10-2024-0098025 filed on Jul. 24, 2024, in the Korean Intellectual Property Office, the disclosures of which are incorporated by reference herein in their entireties.

### BACKGROUND

Embodiments of the present disclosure described herein relate to a calculation device of a deep neural network that converts representation of data and performs calculations and an operation method thereof, and more particularly relate to a calculation device and an operation method that invert and utilize bits of data having negative values.

The recent development of artificial intelligence technology is promoting innovation in various industrial fields. In particular, deep neural networks (DNNs), which consist of an input layer, multiple hidden layers, and an output layer, demonstrate excellent performance in learning and predicting complex data patterns. As a result, DNNs are attracting attention in various deep learning fields such as image recognition, natural language processing, etc.

As the field of deep learning develops, the deep neural networks (DNNs) are gradually becoming larger and more complex. In addition, as the deep neural networks become larger and more complex, the amount of data movement and the amount of calculation inevitably increases.

When the amount of data movement and the amount of calculation increases in a deep neural network, the calculation speed of a memory device or a control device containing the deep neural network may decrease and energy required for calculation may increase.

Therefore, to improve the efficiency of deep neural networks, sparse acceleration technology is being utilized to reduce the amount of calculation and to improve performance by ignoring elements that are “0” or have negligible small values among weights or data of a deep neural network model.

### SUMMARY

Embodiments of the present disclosure provide a calculation device that increases the sparsity of data by inverting and representing at least some bits among a plurality of bits forming data, depending on a sign of a data value.

Embodiments of the present disclosure provide a calculation device that reduces the amount of data movement by compressing data in which at least some of the bits are inverted and represented.

Embodiments of the present disclosure provide a calculation device that improves calculation efficiency by utilizing data in which at least some bits are inverted and represented.

According to an embodiment of the present disclosure, a calculation device of a deep neural network includes a conversion unit that outputs a plurality of conversion data values including bits corresponding to bits included in a plurality of original data values and further including a sign bit based on a sign of each of the plurality of original data values each composed of a plurality of bits, a compression unit that generates compression data including bit vectors in which at least one bit value among a plurality of bit vectors composed of bits having the same number of digits in the plurality of conversion data values is “1”, and a calculation preparation unit that outputs a plurality of recovery data values by inverting a value of at least some bits in each of the plurality of conversion data values, and wherein the conversion unit determines an MSB (most significant bit) of each of the plurality of original data values as the sign bit, and inverts values of bits included in each of original data values whose signs are negative among the plurality of original data values.

According to an embodiment, the compression data may further include a sign bit vector composed of sign bits of each of the plurality of conversion data values.

According to an embodiment, the compression data may further include first index data corresponding to the number of digits of bits forming each of the bit vectors included in the compression data and second index data corresponding to the number of bit vectors included in the compression data.

According to an embodiment, the calculation preparation unit in each of the plurality of conversion data values, in a first bit piece composed of a first number of bits from an LSB, may convert a value of each bit into 2's complement, and when a value of at least one bit among a second bit piece composed of the first number of bits is “1”, may convert a value of each bit included in the second bit piece into the 2's complement.

According to an embodiment, the calculation device may further include a calculation unit that performs a multiplication calculation using the plurality of recovery data values, and the calculation unit may perform the multiplication calculation using recovery pieces which include at least one “1” in each of the plurality of recovery data values.

According to an embodiment, the plurality of original data values may be arranged adjacent to each other in a specified direction within a matrix including the plurality of original data values.

According to an embodiment of the present disclosure, a method of operating a calculation device of a deep neural network includes determining an MSB of each of a plurality of original data values, each of which is composed of a plurality of bits, as a sign bit, converting values of bits included in each of the original data values whose signs are negative among the plurality of original data values into 2's complement based on a value of the sign bit, and outputting a plurality of conversion data values, each of which includes bits corresponding to the bits included in the plurality of original data values and further includes the sign bit.

According to an embodiment, the method of operating the calculation device may further include generating compression data including bit vectors having at least one “1” among a plurality of bit vectors composed of bits having the same number of digits in the plurality of conversion data values, and the compression data may further include a sign bit vector composed of a sign bit of each of the plurality of conversion data values, first index data corresponding to the number of digits of bits forming each of the bit vectors included in the compression data, and second index data corresponding to the number of bit vectors included in the compression data.

According to an embodiment, the method of operating the calculation device may further include, in each of the plurality of conversion data values, converting a value of each bit in a first bit piece composed of a first number of bits from an LSB into 2's complement, and when a value of at least one bit among a second bit piece composed of the first number of bits is “1”, inverting the value of each bit included in the second bit piece to output a plurality of recovery data values.

According to an embodiment, the method of operating the calculation device may further include performing a multiplication calculation on the plurality of recovery data values by using bit pieces including at least one “1” in each of the plurality of recovery data values.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a calculation device, according to an embodiment of the present disclosure.

FIG. 2A illustrates a configuration in which a conversion unit according to an embodiment converts a positive original data value into a conversion data value.

FIG. 2B illustrates a configuration in which a conversion unit according to an embodiment converts a negative original data value into a conversion data value.

FIG. 3 illustrates a configuration in which a plurality of original data values are selected from among original data composed of a matrix, according to an embodiment.

FIG. 4A illustrates a configuration in which a plurality of original data values are sorted according to the number of digits of each bit, according to an embodiment.

FIG. 4B illustrates a configuration in which a plurality of conversion data values are sorted according to the number of digits of each bit, according to an embodiment.

FIG. 4C illustrates compression data, according to an embodiment.

FIG. 5 illustrates a configuration in which a calculation preparation unit according to an embodiment outputs recovery data from conversion data.

FIG. 6 is a block diagram illustrating a calculation device further including a calculation unit, according to an embodiment.

FIG. 7 is a flowchart illustrating an operation method of a calculation device, according to an embodiment.

FIG. 8A is a flowchart illustrating how a calculation preparation unit according to an embodiment outputs a recovery data value from a conversion data value.

FIG. 8B is a flowchart illustrating how a calculation unit according to an embodiment performs a multiplication calculation using recovery data.

### DETAILED DESCRIPTION

Hereinafter, the present disclosure will be described with reference to the attached drawings. While various embodiments of the present disclosure are susceptible to various modifications and have several embodiments, specific embodiments thereof are illustrated by way of an example in the drawings and detailed descriptions thereof will be described. It should be understood, however, that there is no intent to limit the present disclosure to the particular forms disclosed, but on the contrary, the present disclosure is to cover all modifications and/or equivalents, and alternatives falling within the spirit and scope of the present disclosure. With regard to description of drawings, similar elements may be marked by similar reference numerals.

The expressions “include” and “comprise” or “may include” and “may comprise” used in embodiments of the present disclosure indicate existence of corresponding features, operations, or elements disclosed herein but do not exclude additional one or more functions, operations, or elements. Also, it will be further understood that the terms “comprises,” “comprising,” “includes,” and/or “including,” as used herein, specify the presence of stated features, numbers, steps, operations, elements, and/or components, but do not preclude the presence or addition of one or more other features, items, steps, operations, elements, components, and/or groups thereof.

In the present disclosure, expressions such as “or” include any and all combinations of words listed together. For example, the term “A or B” may refer to all of the case (1) where ‘A’ is included, the case (2) where ‘B’ is included, or the case (3) where both of ‘A’ and ‘B’ are included.

The expressions such as “first”, “second”, and the like used in the present disclosure may refer to various elements of the present disclosure, but do not limit the corresponding elements. For example, the terms may not limit order and/or priority of the elements. Such terms may be used to distinguish one element from another element. For example, “a first user device” and “a second user device” may indicate all user devices and may indicate different user devices. For example, a first component may be named as a second component, and vice versa, without departing from the scope of the present disclosure.

It will be understood that when an element is referred to as being “connected” or “coupled” to another element, it may be directly connected or coupled to the other element or intervening elements may be present. In contrast, when an element is referred to as being “directly connected” or “directly coupled” to another element, it should be understood that there are no intervening elements.

Terms used in this disclosure are only used to describe specific embodiments, and are not intended to limit the present disclosure. Singular expressions may include plural expressions unless the context clearly dictates otherwise.

Unless otherwise defined, all terms (including technical and scientific terms) used herein have the same meaning as generally understood by those skilled in the art to which this present disclosure pertains. The terms, such as those defined in commonly used dictionaries, should be interpreted as having a meaning that is consistent with their meaning in the context of the relevant art and will not be interpreted in an idealized or overly formal sense unless expressly so defined herein.

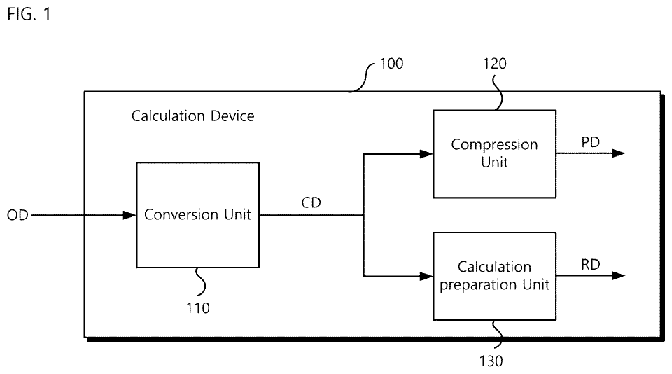

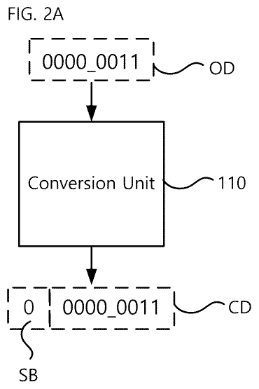

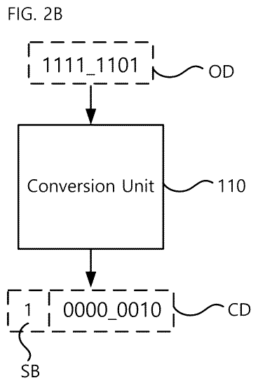

FIG. 1 is a block diagram illustrating a calculation device, according to an embodiment of the present disclosure. FIG. 2A illustrates a configuration in which a conversion unit according to an embodiment converts a positive original data value into a conversion data value. FIG. 2B illustrates a configuration in which a conversion unit according to an embodiment converts a negative original data value into a conversion data value.

Referring to FIG. 1, a calculation device 100 may include a conversion unit 110, a compression unit 120, and a calculation preparation unit 130. However, the calculation device 100 according to another embodiment may further include other components in addition to the components described above, or at least some (e.g., the calculation preparation unit 130) of the components described above may be omitted.

According to an embodiment, the calculation device 100 may be understood as a device connected to a deep neural network (DNN). In more detail, the calculation device 100 may be understood as a device connected to a memory device or a control device that processes (e.g., calculates or moves) data using the deep neural network.

According to another embodiment, the calculation device 100 may be understood as a memory device or a control device that processes (e.g., calculates or moves) data using the deep neural network.

According to an embodiment, the calculation device 100 may include the conversion unit 110 that converts original data OD into conversion data CD. In this case, the original data OD and the conversion data CD may be understood as examples of data processed (or represented) in the operation process of the deep neural network.

In addition, the original data OD may be mixed with the original data value, and the conversion data CD may be mixed with the conversion data value.

In more detail, the conversion unit 110 may convert the original data OD into the conversion data CD further including a sign bit SB based on the sign of the original data OD composed of a plurality of bits.

In this case, the conversion unit 110 according to an embodiment may determine the sign of the original data OD based on the value of an MSB (most significant bit) of the original data OD.

For example, the conversion unit 110 may determine that the sign of the original data OD is positive when the MSB of the original data OD is “0”. For another example, the conversion unit 110 may determine that the sign of the original data OD is negative when the MSB of the original data OD is “1”.

In addition, the conversion unit 110 according to an embodiment may determine the MSB of the original data OD as the sign bit SB of the conversion data CD.

For example, when the value of the MSB of the original data OD is “0”, the conversion unit 110 may determine the value of the sign bit SB of the conversion data CD generated from the original data OD as “0”. For another example, when the value of the MSB of the original data OD is “1”, the conversion unit 110 may determine the value of the sign bit SB of the conversion data CD generated from the original data OD as “1”.

Referring to FIG. 2A, the conversion unit 110 according to an embodiment may convert the original data OD which is a positive number into the conversion data CD whose sign bit SB is “0”.

In this case, bits of the conversion data CD except for the sign bit SB may have the same value as the bits of the original data OD.

That is, according to an embodiment, when the original data OD is a positive number, the conversion unit 110 may output the conversion data CD which includes bits having the same value as the bits of the original data OD and the sign bit SB having the value of “0”.

Referring to FIG. 2B, the conversion unit 110 according to an embodiment may convert the original data OD which is a negative number into the conversion data CD whose sign bit SB is “1”.

In addition, according to an embodiment, the conversion unit 110 may invert the value of each of the plurality of bits forming the original data OD represented in 2's complement.

In more detail, the conversion unit 110 may convert the value of each of the bits having a value of “1” among the bits of the original data OD which is a negative number into “0”. In addition, the conversion unit 110 may convert the value of each of the bits having a value of “O” among the bits of the original data OD which is a negative number into “1”.

Therefore, the value of each of the bits forming the conversion data CD may be understood as a value obtained by inverting the value of each of the bits forming the original data OD which is a negative number.

That is, according to an embodiment, when the original data OD represented in 2's complement is a negative number, the conversion unit 110 may output the conversion data CD including bits having a value obtained by inverting the value of each of the bits of the original data OD and the sign bit SB having a value of “1”.

Referring to the above-described configurations, the conversion unit 110 according to an embodiment may convert “1” included in the original data OD into “0” when the original data OD is a negative number.

Through this, the conversion unit 110 may generate the conversion data CD having a relatively smaller number of “1s” and a relatively larger number of “0s” compared to the original data OD.

Furthermore, the calculation device 100 (or, the deep neural network) may perform data movement or calculation using the conversion data CD containing a relatively larger number of “0s” compared to the original data OD.

Through this, the calculation device 100 according to the embodiment of the present disclosure may reduce the time and energy required for the deep neural network to move or calculate data.

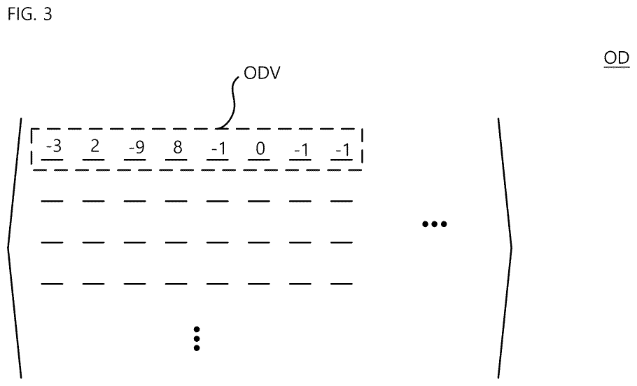

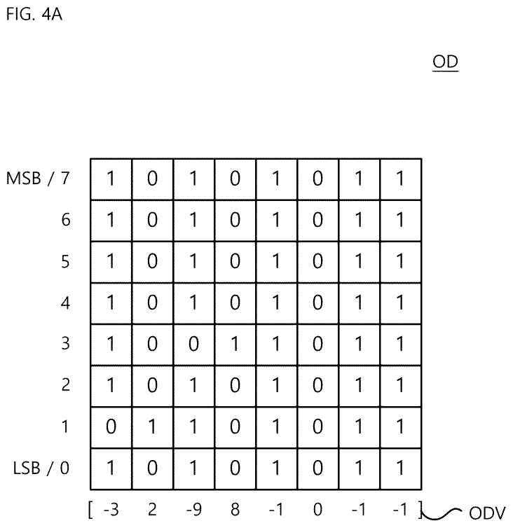

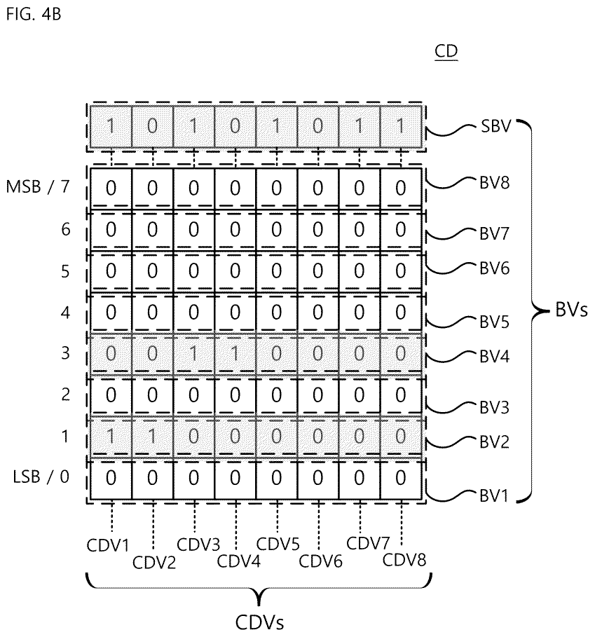

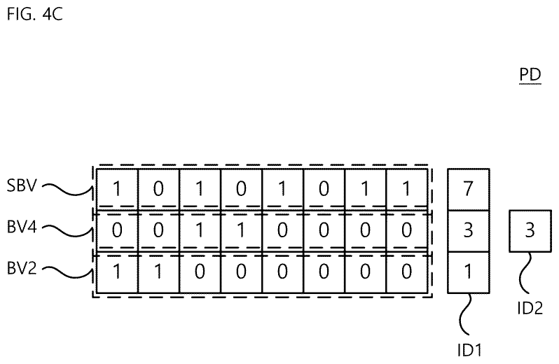

FIG. 3 illustrates a configuration in which a plurality of original data values are selected from among original data composed of a matrix, according to an embodiment. FIG. 4A illustrates a configuration in which a plurality of original data values are sorted according to the number of digits of each bit, according to an embodiment. FIG. 4B illustrates a configuration in which a plurality of conversion data values are sorted according to the number of digits of each bit, according to an embodiment. FIG. 4C illustrates compression data, according to an embodiment.

Referring to FIG. 1 and FIG. 3 to FIG. 4C together, the calculation device 100 (or the compression unit 120) according to an embodiment may compress a plurality of original data values ODV to output compression data PD.

Referring to FIG. 1 and FIG. 3, the calculation device 100 according to an embodiment may select the plurality of original data values ODV from the original data OD.

In more detail, the calculation device 100 (or the conversion unit 110) may select the plurality of original data values ODV that are adjacent to each other among the original data OD represented in the form of a matrix.

In this case, each of the plurality of original data values ODV illustrated in FIG. 3 may be understood as being represented in decimal.

The calculation device 100 may select the plurality of original data values ODV that are adjacent to each other in a specified direction among the original data OD represented in the form of a matrix.

For example, referring to FIG. 3, the calculation device 100 may select 8 original data values ODV adjacent in a row direction from among the original data OD represented in a matrix.

For another example, the calculation device 100 may select 16 original data values ODV adjacent in a column direction from among the original data OD represented in a matrix.

For another example, the calculation device 100 may select 6 original data values ODV arranged in a 2×3 array from among the original data OD represented in a matrix.

However, the method by which the calculation device 100 selects the plurality of original data values ODV from the original data OD is not limited to the above-described examples, and may be understood as various methods of selecting values adjacent to each other from among the values included in the original data OD.

Referring to FIG. 1 and FIG. 4A, the calculation device 100 according to an embodiment may align a plurality of bits forming each of the plurality of original data values ODV depending on the number of digits of each bit.

In more detail, the calculation device 100 may represent each of the plurality of original data values ODV represented in binary by aligning them according to the number of digits of the bits from the least significant bit (LSB) to the most significant bit (MSB).

For example, the original data OD in which the plurality of original data values ODV represented in binary are aligned according to the number of digits of the bits may have a matrix form.

Here, for example, a row may correspond to each of the plurality of original data values ODV. In addition, a column may correspond to the number of digits of the bits forming each of the plurality of original data values ODV represented in binary.

Further, referring to FIG. 4B, the calculation device 100 (or, the conversion unit 110) according to an embodiment may invert the value of each bit of a negative value among the plurality of original data values ODV.

In this case, the operation of inverting the value of the bit may be understood as including an operation of converting the value of the bit to “0” when the value of the bit is “1”, and converting the value of the bit to “1” when the value of the bit is “0”.

In addition, the conversion unit 110 may determine the MSB of each of the plurality of original data values ODV represented in binary as the sign bit of each data value.

That is, the conversion unit 110 may convert the plurality of original data values ODV into a plurality of conversion data values CDVs that further include a sign bit.

For example, the conversion unit 110 may convert the original data value “−3” into a first conversion data value CDVI that further includes a sign bit “1”. For another example, the conversion unit 110 may convert the original data value “8” into a fourth conversion data value CDV4 that further includes a sign bit “0.”

In this case, the conversion data CD may include a plurality of bit vectors BVs that include bits having the same number of digits among the plurality of conversion data values CDVs.

That is, each of the plurality of bit vectors BVs may be understood as a set of bits having the same number of digits among each of the plurality of conversion data CDVs represented in binary.

For example, the conversion data CD may include a first bit vector BV1 composed of bits (e.g., LSB) of the first digit of each of the plurality of conversion data values CDVs. For another example, the conversion data CD may include an eighth bit vector BV8 composed of bits (e.g., MSB) of the eighth digit in each of the plurality of conversion data values CDVs. For another example, the conversion data CD may include a sign bit vector SBV composed of a sign bit of each of the plurality of conversion data values CDVs.

According to an embodiment, the compression unit 120 may identify bit vectors including at least one “1” among the plurality of bit vectors BVs.

For example, referring to FIG. 4B, the compression unit 120 may identify a second bit vector BV2 and a fourth bit vector BV4 that each includes at least one “1” among the plurality of bit vectors BVs.

Furthermore, the compression unit 120 may generate the compression data PD including the identified bit vectors and the sign bit vector SBV.

In more detail, the compression unit 120 may generate the compression data PD including bit vectors including at least one “1” among the plurality of bit vectors BVs and the sign bit vector SBV.

For example, referring to FIG. 4C, the compression unit 120 according to an embodiment may generate the compression data PD including the second bit vector BV2, the fourth bit vector BV4, and the sign bit vector SBV.

In addition, the compression data PD according to an embodiment may include first index data ID1 corresponding to the number of digits of bits forming each of the bit vectors included in the compression data PD.

In more detail, the compression data PD may include the first index data ID1 corresponding to the number of digits that each of the bits forming the bit vectors included in the compression data PD has in the plurality of conversion data values CDVs.

For example, the compression data PD may include the first index data ID1 including a value corresponding to the number of digits “1” of bits forming the second bit vector BV2. In addition, the compression data PD may include the first index data ID1 including a value corresponding to the number of digits “3” of bits forming the fourth bit vector BV4. In addition, the compression data PD may include the first index data ID1 including a value corresponding to the number of digits “7” of bits forming the sign bit vector SBV.

Here, for example, since the sign bit vector SBV is determined by the MSB of each of the plurality of conversion data values CDVs, the value corresponding to the number of digits of the bits forming the sign bit vector SBV may be determined as “7”, which is the same as the number of digits of the MSB.

In addition, the compression data PD may include second index data ID2 corresponding to the number of bit vectors included in the compression data PD.

For example, when the compression data PD includes the second bit vector BV2, the fourth bit vector BV4, and the sign bit vector SBV, the compression data PD may include the second index data ID2 having a value of “3” indicating that the compression data PD includes a total of three bit vectors.

Referring to the above-described configurations, the compression unit 120 according to an embodiment may generate the compression data PD including bit vectors including at least one “1” among the conversion data CD that is converted to include relatively more “0s” compared to the original data OD.

Furthermore, the calculation device 100 may move the compression data PD when data movement is required during the operation of the deep neural network. For example, the calculation device 100 may move the compression data PD when data movement is required from the memory device to the control device during the operation of the deep neural network.

That is, the calculation device 100 may reduce the amount of data to be moved. Through this, the calculation device 100 according to the embodiment of the present disclosure may reduce the time and/or energy required to move the data.

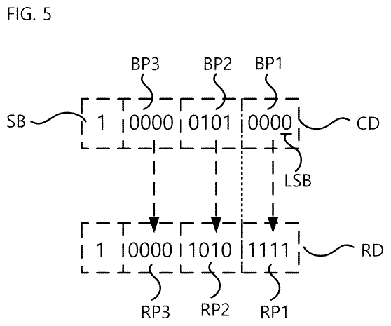

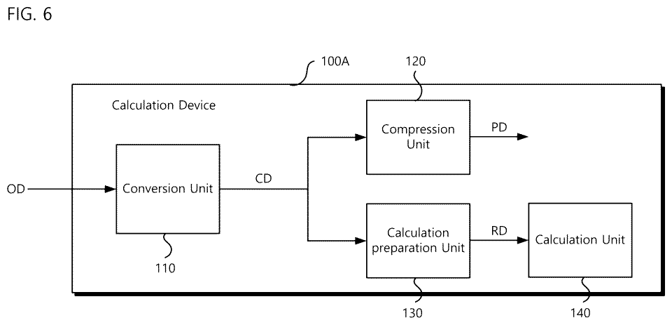

FIG. 5 illustrates a configuration in which a calculation preparation unit according to an embodiment outputs recovery data from conversion data. FIG. 6 is a block diagram illustrating a calculation device further including a calculation unit, according to an embodiment.

Referring to FIG. 1 and FIG. 5 together, the calculation preparation unit 130 according to an embodiment may output recovery data RD from the conversion data CD. In more detail, the calculation preparation unit 130 may invert the value of at least some bits of the conversion data CD to generate the recovery data RD.

According to an embodiment, the calculation preparation unit 130 may invert the value of each bit of a first bit piece BP1 composed of a first number of bits from the LSB among the bits of the conversion data CD (or, the conversion data value).

Here, the conversion data CD may be understood as including a plurality of bit pieces BP1, BP2, and BP3 each composed of a first number of bits.

Therefore, the calculation preparation unit 130 may generate the recovery data RD including a plurality of recovery pieces RP1, RP2, and RP3 corresponding to each of the plurality of bit pieces BP1, BP2, and BP3 by inverting the values of at least some of the plurality of bit pieces BP1, BP2, and BP3.

In this case, each of the plurality of bit pieces BP1, BP2, and BP3 and the plurality of recovery pieces RP1, RP2, and RP3 may be understood as a unit that divides a data value represented in binary into a specified number of bits.

For example, referring to FIG. 5, the calculation preparation unit 130 may convert the values of each of the four bits from the LSB of the conversion data CD from “0” to “1”. That is, the calculation preparation unit 130 may invert the value “0000” of the first bit piece BP1 to generate the first recovery piece RP1 having the value “1111”.

In addition, the calculation preparation unit 130 according to an embodiment may invert the value of each of the bits included in the second bit piece BP2 when at least some of the values of the bits included in the second bit piece BP2 are “1”.

In more detail, the calculation preparation unit 130 may invert the value of each of the bits included in the second bit piece BP2 when at least some of the values of the bits included in the second bit piece BP2 that are distinct from the first bit piece BP1 are “1”.

For example, in response to the fact that two bits in the second bit piece BP2 have values of “1”, the calculation preparation unit 130 may invert the value “0101” of the second bit piece BP2 to generate the second recovery piece RP2 having the value of “1010”.

In contrast, the calculation preparation unit 130 according to an embodiment may determine the value of the third bit piece BP3 as the value of the third recovery piece RP3 when the values of the bits included in the third bit piece BP3 are all “0”.

In more detail, the calculation preparation unit 130 may determine the value of the third bit piece BP3 as the value of the third recovery piece RP3 corresponding to the third bit piece BP3 in the recovery data RD when the values of the bits included in the third bit piece BP3 are all “0”.

For example, the calculation preparation unit 130 may determine the value “0000” of the third bit piece BP3 as the value of the third recovery piece RP3 in response to the fact that all of the bits included in the third bit piece BP3 are “0”.

Furthermore, referring to FIG. 6, a calculation device 100A according to an embodiment may further include an calculation unit 140.

In this case, the calculation device 100A illustrated in FIG. 6 may be understood as an example of the calculation device 100 illustrated in FIG. 1. Accordingly, the same reference numerals are used for components that are the same or actually the same as the above-described components, and additional descriptions that may overlap with the above-described content will be omitted to avoid redundancy.

According to an embodiment, the calculation unit 140 may perform a multiplication calculation using the recovery data RD.

In more detail, the calculation unit 140 may perform the multiplication calculation using the recovery pieces (e.g., the first recovery piece RP1 and the second recovery piece RP2) that include at least one “1” in each of the plurality of recovery data values included in the recovery data RD.

In this case, for example, the calculation unit 140 may be understood as a part of the deep neural network that performs a multiplication calculation, but is not limited thereto.

Referring to the above-described configurations, the calculation preparation unit 130 according to an embodiment may generate the recovery data RD in which the values of bits that do not affect the multiplication calculation are represented as “0” based on the conversion data CD.

Furthermore, the calculation unit 140 may perform the multiplication calculation using bits excluding bits (or bit pieces) that do not affect the multiplication calculation.

Through this, the calculation device 100A according to an embodiment of the present disclosure may reduce the time and/or energy required for a deep neural network to calculate data.

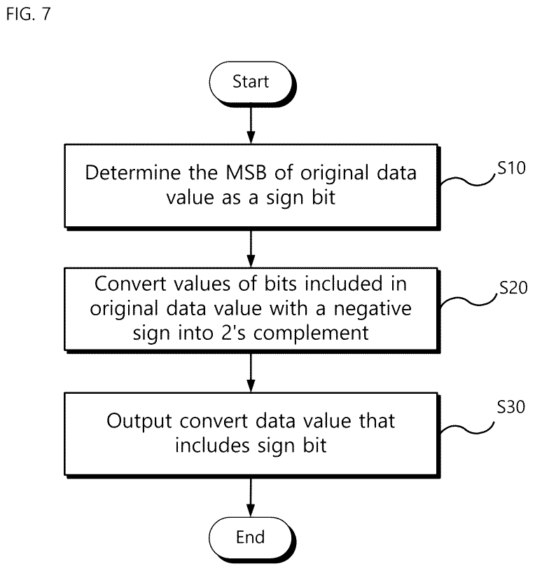

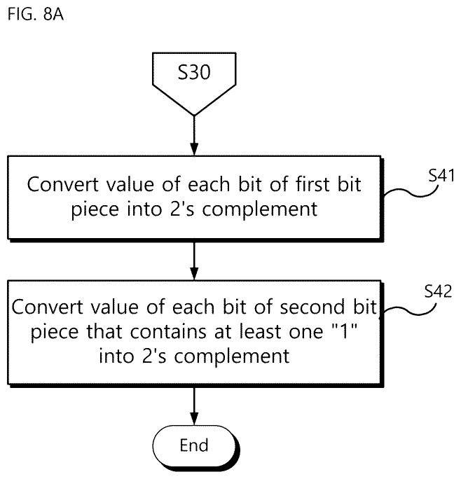

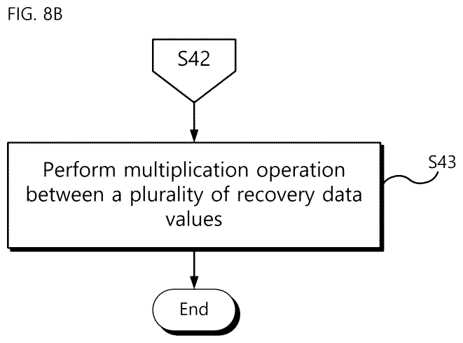

FIG. 7 is a flowchart illustrating an operation method of a calculation device, according to an embodiment. FIG. 8A is a flowchart illustrating how a calculation preparation unit according to an embodiment outputs a recovery data value from a conversion data value. FIG. 8B is a flowchart illustrating how a calculation unit according to an embodiment performs a multiplication calculation using recovery data.

Referring to FIG. 7, the calculation device 100 (or the conversion unit 110) according to an embodiment may output the conversion data CD based on the original data OD.

In more detail, the calculation device 100 may output the plurality of conversion data values CDVs that relatively include more bits with a value of “0” from the plurality of original data values ODVs.

In operation S10, the calculation device 100 according to an embodiment may determine the value of the MSB of the original data value as the value of the sign bit SB of the conversion data value.

In more detail, the calculation device 100 may determine the MSB of each of the plurality of original data values ODVs each composed of a plurality of bits as the sign bit SB of each of the plurality of conversion data values CDVs.

For example, when the value of the MSB of the original data OD is “0”, the calculation device 100 may determine the value of the sign bit SB of the conversion data CD generated from the original data OD as “0”.

For another example, when the value of the MSB of the original data OD is “1”, the calculation device 100 may determine the value of the sign bit SB of the conversion data CD generated from the original data OD as “1”.

In operation S20, the calculation device 100 according to an embodiment may invert the value of each of the bits included in the original data OD which is a negative number.

In more detail, the calculation device 100 may invert the value of each of the bits included in each of the original data values ODVs whose signs are negative based on the value of the sign bit SB.

For example, the calculation device 100 may convert the values of bits included in the original data OD “11111101” into the conversion data CD “00000010”.

Furthermore, in operation S30, the calculation device 100 according to an embodiment may output the conversion data CD including the bits converted to 2's complement and the sign bit SB.

In more detail, the calculation device 100 may output the plurality of conversion data values CDVs including the bits corresponding to the bits included in the plurality of original data values ODVs and further including the sign bit SB.

Referring to the above-described configurations, the calculation device 100 according to an embodiment may convert “1” included in the original data OD into “0” when the original data OD is a negative number. Through this, the calculation device 100 may generate the conversion data CD having a relatively smaller number of “1s” and a relatively larger number of “0s” compared to the original data OD.

Furthermore, the calculation device 100 (or, the deep neural network) may perform data movement or calculation using the conversion data CD containing a relatively larger number of “0s” compared to the original data OD.

Through this, the calculation device 100 according to the embodiment of the present disclosure may reduce the time and energy required for the deep neural network to move or calculate data.

In addition, referring to FIG. 7 and FIG. 8A together, the calculation device 100 (or, the calculation preparation unit 130) according to an embodiment may output the recovery data RD from the conversion data CD. In more detail, the calculation device 100 may invert the value of at least some bits of the conversion data CD to generate the recovery data RD.

In operation S41, the calculation device 100 according to an embodiment may invert the value of each bit included in the first bit piece BP1 composed of the first number of bits from the LSB among the conversion data CD (or, the conversion data value).

In more detail, the calculation device 100 may invert the value of each bit in the first bit piece BP1 composed of the first number of bits from the LSB.

For example, the calculation device 100 may convert the value of each of the four bits from the LSB among the conversion data CD from “0” to “1”. That is, the calculation preparation unit 130 may invert the value “0000” of the first bit piece BP1 to generate the first recovery piece RP1 having the value “1111”.

In operation S42, the calculation device 100 according to an embodiment may invert the value of each bit included in the second bit piece BP2.

In more detail, the calculation device 100 may invert the value of each of the bits included in the second bit piece BP2 when at least one bit of the second bit piece BP2 composed of the first number of bits has a value of “1”.

The calculation device 100 may invert the value of each of the bits included in the second bit piece BP2 when at least some of the bits included in the second bit piece BP2 that are distinct from the first bit piece BP1 have a value of “1”.

For example, in response to the fact that two bits in the second bit piece BP2 have values of “1”, the calculation device 100 may invert the value “0101” of the second bit piece BP2 to generate the second recovery piece RP2 having the value of “1010”.

In contrast, the calculation device 100 according to an embodiment may determine the value of the third bit piece BP3 as the value of the third recovery piece RP3 when the values of the bits included in the third bit piece BP3 are all “0”.

In more detail, the calculation device 100 may determine the value of the third bit piece BP3 as the value of the third recovery piece RP3 corresponding to the third bit piece BP3 in the recovery data RD when the values of the bits included in the third bit piece BP3 are all “0”.

For example, the calculation device 100 may determine the value “0000” of the third bit piece BP3 as the value of the third recovery piece RP3 in response to the fact that all of the bits included in the third bit piece BP3 are “0”.

According to an embodiment, the calculation device 100 may output the recovery data RD including the first recovery piece RP1, the second recovery piece RP2, and the third recovery piece RP3.

Furthermore, referring to FIG. 8B, the calculation device 100 (or the calculation unit 140) according to an embodiment may perform a multiplication calculation using at least some bits of the recovery data RD.

In operation S43, the calculation device 100 according to an embodiment may perform a multiplication calculation between a plurality of recovery data values.

In more detail, the calculation device 100 may perform a multiplication calculation using recovery pieces (e.g., the first recovery piece RP1 and the second recovery piece RP2) that include at least one “1” in each of the plurality of recovery data values included in the recovery data RD.

Referring to the above-described configurations, the calculation device 100 according to an embodiment may generate the recovery data RD in which the values of bits that do not affect the multiplication calculation are represented as “0” based on the conversion data CD.

Furthermore, the calculation device 100 may perform the multiplication calculation using bits excluding bits (or bit pieces) that do not affect the multiplication calculation.

Through this, the calculation device 100 according to an embodiment of the present disclosure may reduce the time and/or energy required for a deep neural network to calculate data.

According to an embodiment of the present disclosure, the calculation device may reduce the amount of data movement of a deep neural network, thereby reducing the energy required to move data.

In addition, according to an embodiment of the present disclosure, the calculation device may reduce the time and energy required for a deep neural network to calculate on data.

As described above, the present disclosure has been described with reference to the illustrative drawings, but the present disclosure is not limited to the embodiments and drawings disclosed herein, and it will be obvious that various modifications may be made by those skilled in the art within the scope of the technical spirit of the present disclosure. In addition, although the operational effects according to the configuration of the present disclosure are not explicitly described while describing the embodiments of the present disclosure above, it will be obvious that the predictable effects by the configuration should also be recognized.

What is claimed is:

1. A calculation device of a deep neural network, the calculation device comprising:
a conversion unit configured to output a plurality of conversion data values including bits corresponding to bits included in a plurality of original data values and further including a sign bit, based on a sign of each of the plurality of original data values each composed of a plurality of bits;
a compression unit configured to generate compression data including bit vectors in which at least one bit value among a plurality of bit vectors composed of bits having the same number of digits in the plurality of conversion data values is “1”; and
a calculation preparation unit configured to output a plurality of recovery data values by inverting a value of at least some bits in each of the plurality of conversion data values, and
wherein the conversion unit is configured to:
determine an MSB (most significant bit) of each of the plurality of original data values as the sign bit; and
invert values of bits included in each of original data values whose signs are negative among the plurality of original data values.

2. The calculation device of claim 1, wherein the compression data further includes a sign bit vector composed of sign bits of each of the plurality of conversion data values.

3. The calculation device of claim 2, wherein the compression data further includes first index data corresponding to the number of digits of bits forming each of the bit vectors included in the compression data, and second index data corresponding to the number of bit vectors included in the compression data.

4. The calculation device of claim 1, wherein the calculation preparation unit, in each of the plurality of conversion data values:
in a first bit piece composed of a first number of bits from an LSB, converts a value of each bit into 2's complement; and
when a value of at least one bit among a second bit piece composed of the first number of bits is “1”, converts a value of each bit included in the second bit piece into the 2's complement.

5. The calculation device of claim 4, further comprising:
a calculation unit configured to perform a multiplication calculation using the plurality of recovery data values; and
the calculation unit performs the multiplication calculation using recovery pieces which include at least one “1” in each of the plurality of recovery data values.

6. The calculation device of claim 1, wherein the plurality of original data values are arranged adjacent to each other in a specified direction within a matrix including the plurality of original data values.

7. A method of operating a calculation device of a deep neural network, the method comprising:
determining an MSB of each of a plurality of original data values, each of which is composed of a plurality of bits, as a sign bit;
converting values of bits included in each of the original data values whose signs are negative among the plurality of original data values into 2's complement based on a value of the sign bit; and
outputting a plurality of conversion data values, each of which includes bits corresponding to the bits included in the plurality of original data values and further includes the sign bit.

8. The method of claim 7, further comprising:
generating compression data including bit vectors having at least one “1” among a plurality of bit vectors composed of bits having the same number of digits in the plurality of conversion data values, and
wherein the compression data further includes:
a sign bit vector composed of a sign bit of each of the plurality of conversion data values;
first index data corresponding to the number of digits of bits forming each of the bit vectors included in the compression data; and
second index data corresponding to the number of bit vectors included in the compression data.

9. The method of claim 7, further comprising:
in each of the plurality of conversion data values,
converting a value of each bit in a first bit piece composed of a first number of bits from an LSB into 2's complement; and
when a value of at least one bit among a second bit piece composed of the first number of bits is “1”, inverting the value of each bit included in the second bit piece to output a plurality of recovery data values.

10. The method of claim 9, further comprising:
performing a multiplication calculation on the plurality of recovery data values by using bit pieces including at least one “1” in each of the plurality of recovery data values.
